(19) United States
(12) Patent Application Publication
(10) Pub. No.: US 2016/0311636 A1
(43) Pub. Date: Oct. 27, 2016

(54) Hand-held tool for separating plastic bags

(71) Applicant: Greg Duda, Mesa, AZ (US)

(72) Inventor: Greg Duda, Mesa, AZ (US)

(21) Appl. No.: 14/693,882

(22) Filed: Apr. 23, 2015

(51) Int. Cl. B65H 3/02; B25J 1/00

(52) U.S. Cl. CPC B65H 3/02; B25J 1/00

(57) ABSTRACT

This invention proposes a hand-held tool designed to separate and open up flat, layered, hard-to-grasp objects, such as plastic bags. An example situation which calls for such a tool is the self-checkout lane a in modern supermarket. In self-checkout lanes, both the supermarket staff and shoppers are often faced with tightly-packed bundles of shopping bags made of biodegradable plastic. These bags tend to be thin, slippery and very hard to peel off each other, so that the supermarket staff and customers often resort to licking their fingers, fumbling around to separate small bits of the shopping bag, or even applying wet rags, etc. The tool described herein allows the staff or the shoppers to easily open up a plastic bag of this kind.

### CROSS-REFERENCE TO RELATED APPLICATIONS

Not applicable

### FEDERALLY SPONSORED RESEARCH

Not applicable

### SEQUENCE LISTING OR PROGRAM

Not applicable

### BACKGROUND

1. Field

This invention presents a hand-held tool designed to easily open tightly-packed plastic bags. An example of a situation for which this tool would be of particular use is the self-checkout lane in a modern supermarket. There, supermarket staff and shoppers are frequently faced with tightly-packed bundles of biodegradable shopping bags. These bags are thin and slippery. They are hard to separate and open without resorting to licking one's fingers, fumbling around to find any parts of the shopping bag that are already separated, etc. The present invention offers a solution to this problem.

2. Prior Art

In recent years, more and more shoppers in modern supermarkets check out using the self-checkout lane. A standard fixture of such a self-checkout lane is a bundle of tightly-packed plastic shopping bags. These bags are made of a biodegradable material which is thin and slippery. This type of material makes the bags hard to separate and open easily. Faced with such hard-to-open bags, most supermarket staff and shoppers resort to licking their fingers, searching around to find any bits of the bag that are already separated, or even using wet rags to open up a bag.

Very few solutions have been offered so far to remedy this problem. The only US patent that addresses this problem is US 20070059471A1 issued to Sanford. This patent describes a small, thin, foldable book-like gadget designed to separate both sides of a plastic bag. However, this solution has several problems:
a) it can only open up a bag when both sides of the bag are accessible, it can't deal with the most frequent situation in a self-checkout lane where only one side of the bag is accessible,
b) the gadget is thin and flimsy, and designed more as a gimmick offering advertising space, not a professional tool fit for everyday use by the supermarket staff,
c) because the gadget has sticky surfaces, it requires the user to manually separate the tool from the bag after use, which in itself is as cumbersome as the problem it intends to solve.

The goal of the present invention is to offer a solution to the problem which eliminates the above-mentioned drawbacks. The solution offered herein presents a tool with the following advantages:
a) it is simple to use,
b) it is sturdy; it can withstand long-term, heavy-duty professional use,
c) it can cope with thin, slippery, hard-to-grasp materials,
d) it can cope with situations where only one side of a plastic bag is accessible.
e) it doesn't require the user to separate the tool from the bag after use.

### SUMMARY

Described herein is a hand-held tool which easily opens tightly-packed plastic bags. Both the supermarket staff and shoppers can use it to separate hard-to-open plastic shopping bags typically encountered in self-checkout lanes in supermarkets. The primary target of this invention are the biodegradable plastic shopping bags, usually made of thin, slippery, hard-to-grasp material. While the above situation is typical for the intended use, it should be noted that the tool described herein can be used to separate or open up other types of flat, layered goods, such as plastic trash bags, sheets of paper, layers of foil or fabric, etc.

### DRAWINGS

FIG. 1 is a perspective view showing the frontal, active side of the tool,

FIG. 2 is a perspective view of the back of the tool, where a handgrip is located,

FIG. 3 shows an example of how the tool would be used to open a shopping bag hung on a rack of the type often encountered in modern supermarkets.

### DETAILED DESCRIPTION

The basic idea behind this invention is to provide the user with a hand-held tool equipped with a firm, frictional surface element. This frictional element is swiped by the user against the front-facing side of the shopping bag in order to slide it against the layer immediately behind it. The front-facing side of the bag can thus be peeled off, the two sides of the shopping bag separated, and the shopping bag opened up.

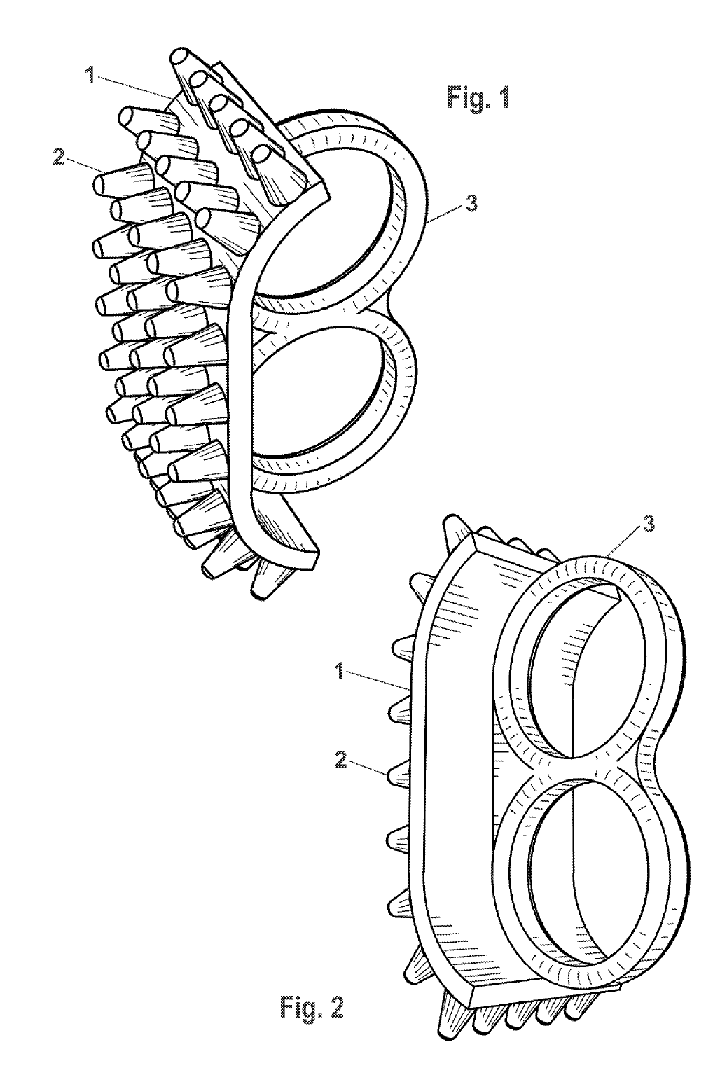

FIG. 1 shows one possible embodiment of such a tool. In this embodiment the frictional element 2 takes the form of an array of spikes made of a flexible material with a high friction coefficient, such as silicone or rubber. These spikes are affixed atop the back plate 1 made of a hard plastic such as PET, PVC, polypropylene, etc. FIG. 2 shows the back of the tool with the handgrip 3, made of a similar plastic. In this embodiment the handgrip takes the form of two rings designed to fit the index and middle fingers of the user's hand.

Operation

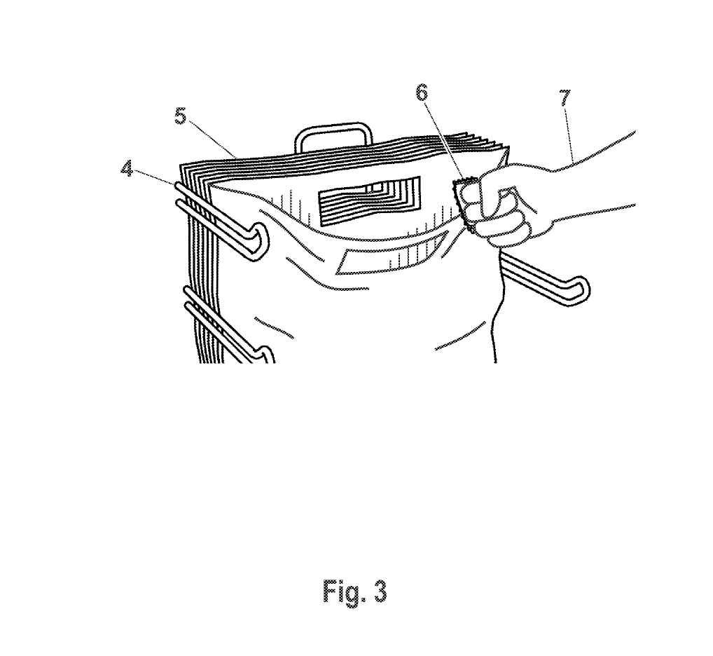

FIG. 3 shows the typical usage of the tool. Grasping the tool 6 firmly with his or her hand 7, the user applies it against the surface of the shopping bag in a downward swiping motion, so that the frictional element engages the surface of the shopping bag. The user is thus able to slide the frontmost side of the shopping bag against the layer immediately behind it. The front layer crinkles up and peels off. The user is then able to separate the two sides of the shopping bag, open the bag up and gain access to its interior.

Ramifications

The described tool is just but one of many possible embodiments. Notably, the frictional element 2 can take many different forms: cones, spikes, a tire-like tread, bumps, an array of pyramid-like shapes, ridges, etc. Similarly, the handgrip 3 can be designed to be worn on two fingers, such as the index and middle fingers, or the whole palm. The handgrip can be separated into individual rings or it can be open, so that there are no subdivisions for individual fingers.

The primary target of this invention are the thin, slippery, biodegradable plastic bags used in self-checkout lanes in modern supermarkets. Nevertheless, this tool can be used to separate other tightly-packed, hard-to-grasp, layered goods, such as thrash bags, sheets of paper, layers or foil or fabric, etc.

### CONCLUSION

The proposed invention offers the following advantages:
a) it is simple to use,
b) it is sturdy
c) it can withstand long-term, heavy-duty, professional use,
d) it can cope with situations where only one side of a plastic bag is exposed,
e) does not require the user to separate the tool from the plastic bag after use.

I claim:

1. A hand-held tool to separate layers of flat, tightly-packed, hard-to-grasp objects, examples of such objects including plastic shopping bags, sheets of paper, etc, said tool comprising:
a) a plurality of protruding, flexible features disposed on the outward-facing or active side of said tool, said protruding features designed to frictionally engage the surface of said flat object when the user swipes said tool against the surface of said flat object,
b) a holding means on the inward-facing side allowing the tool to be held by the user.

2. A hand-held tool of claim 1 wherein said holding means slides onto the user's two fingers: the index and the middle finger.

3. A hand-held tool of claim 1 wherein said holding means is gripped by the user's entire palm.
